(19) United States
(12) Patent Application Publication
(10) Pub. No.: US 2006/0017730 A1
(43) Pub. Date: Jan. 26, 2006

(54) Stepless 3d texture mapping in computer graphics

(75) Inventor: Kornelis Meinds, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N. V., Eindhoven (NL)

(21) Appl. No.: 10/502,965

(22) PCT Filed: Jan. 30, 2003
(86) PCT No.: PCT/IB03/00339

§ 371 Date: Jul. 29, 2004

(30) Foreign Application Priority Data
Feb. 1, 2002 (EP) 02075421.4

(51) Int. Cl. G09G 5/00; G06T 15/10; G06T 15/20

(52) U.S. Cl. 345/427; 345/582

(57) ABSTRACT

Spatial transformation of an input image array of first sampled signals to an output image array of second sampled signals is executed by for each second sampled signal accumulating a finite set of products that are each generated by implementing a filter transform function value, times the various applicable ones of said first sampled signals. In particular, the method is applied to steplessly variable sample-rate-conversion used in a two-pass forward mapping procedure for in a three-dimensional graphics pipeline effecting texture mapping.

### BACKGROUND OF THE INVENTION

The invention relates to a method as recited in the preamble of Claim 1. A prime field of application of such transforms is the changing of scale of digital images, such as black-and-white and colour photographs, video images, and other. The scaling factors may be non-uniform over the image. A typical example of application of the invention would be a perspective transformation of an image that implies texture mapping in a three-dimensional graphics system.

Earlier art disclosed in U.S. Pat. No. 5,892,695 to Van Dalfsen et al, and furthermore Patent Application PHNL010300, filed May 15, 2001, both assigned to the present assignee and herein incorporated by reference, execute Sample Rate Conversion using a transposed direct-form structure, with the object to scale video images without introducing aliasing during the process.

Texture mapping has proved a useful functionality for application in a three-dimensional graphics system. Although such texture mapping would be feasible for execution through inverse texture mapping, it would be quite costly and complex to raise the image quality by implementing an enhanced filter facility using such inverse texture mapping. Now, the present inventors have recognized that certain existent FIR filter structures may be advantageously applied to new fields of technology as will be discussed hereinafter.

### SUMMARY TO THE INVENTION

In consequence, amongst other things, it is an object of the present invention to raise the quality of the texture mapping filtering procedure, which filtering should be effected at a high throughput rate with memory accesses, and at a low price/performance ratio. The adding of perspective image filtering should preferably re-use to an appreciable degree such hardware that is already present in prior art video scaling and filtering systems. Furthermore, similar approaches should be able to cope with texture filtering of still images and also of perspective or otherwise non-uniformly warped video images. The system should furthermore allow for executing both affine and non-affine transformations.

Now therefore, according to one of its aspects the invention is characterized according to the characterizing part of Claim 1.

The invention also relates to an apparatus being arranged for implementing a method as claimed in Claim 1. Further advantageous aspects of the invention are recited in dependent Claims.

### BRIEF DESCRIPTION OF THE DRAWING

These and further aspects and advantages of the invention will be discussed more in detail hereinafter with reference to the disclosure of preferred embodiments, and in particular with reference to the appended Figures that show:

FIG. 1, an elementary block diagram of a 3-D pipeline structure;

FIGS. 2a, 2b, the contributing from a mapped texel to various pixels in screen space;

FIG. 3, a more detailed block diagram of the resample and filter unit of FIG. 1;

FIG. 4, a polyphase transposed direct-form single-table FIR filter structure that can be used with the present invention;

FIG. 5, a polyphase direct form FIR filter structure that can be used with the present invention.

### DETAILED DESCRIPTION OF PREFERRED EMBODIMENTS

Hereinafter, the input samples of an image will be called texels that collectively form an input space or texture (space) or texture. Conversely, the output samples will be called pixels that collectively form an output space, image space or (screen) pixel space. One of the most simple filtering methods is bi-linear filtering, wherein the coordinate of the inverse mapped pixel is calculated in texture. The colour is then calculated through interpolating as based on the various distances from the mapped pixel to the four closest texels. However, it has been found in the practicing of the prior art as sketched, as well in various amplifications and extensions thereof, that numerous aliasing artefacts would occur in the eventual result of the filtering.

Therefore, the invention proposes a method for hardware implementation that can use various different filter functions, and furthermore, use all the texels covered by the pre-image region. In principle, the use of such texels that lie outside the pre-image region would be feasible as well. The invention effectively presents a method that in its most preferred embodiment combines the two-pass forward texture mapping method with a so-called polyphase FIR (finite impulse response) filter structure for the texture filtering. Less preferred embodiments include one-pass forward texture mapping and furthermore, also inverse texture mapping.

Commonly, a sample-rate conversion that uses a polyphase FIR filter structure has been applied in video processing, for executing affine video scaling. According to the present invention, it is possible to re-use that same kind of filter facility to have it execute the functions as disclosed hereinafter, by only a very moderate extension of the associated hardware, or even no extension at all. Apparently, such double use of the hardware will be cost effective.

Various operations are performed as follows. Forward texture mapping will rasterize a polygon in texture space. For every texel in the polygon, it is determined to which pixel(s) the texel in question will contribute. The texel-to-pixel mapping can be effected in a one-pass or in a two-pass organization. Two-pass forward mapping is based on splitting a single two-dimensional perspective transformation or other transformation into two separate one-dimensional perspective transformations or other transformations. By itself, such has been disclosed in the Catmull-Smith, 1980, publication. For example, when using a standard orthogonal coordinate system, first a horizontal transformation and filtering pass is applied to map all rows of the input space onto respective rows of an intermediate space. Subsequently, the columns of the intermediate space are vertically transformed and mapped to the output space. The inverse sequence among vertical and horizontal filtering passes is equally viable.

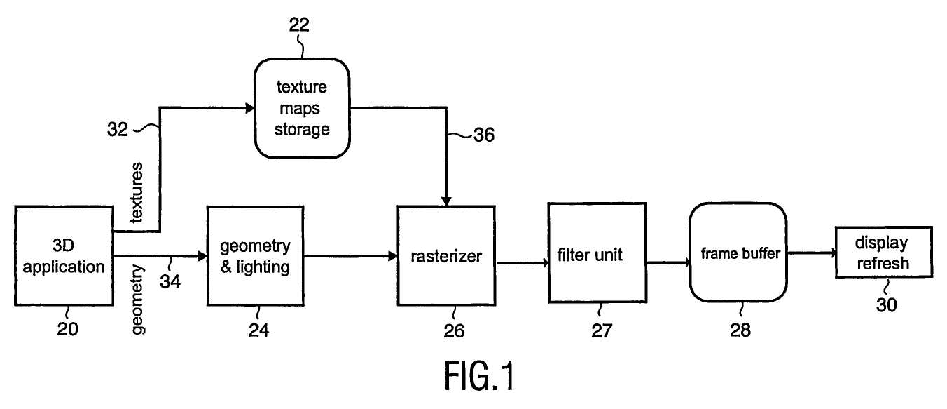

FIG. 1 illustrates an elementary block diagram of a 3-D pipeline structure. Herein, a three-dimensional application 20 generates 3D model data and texture data. The latter information is separated onto line 32 and transiently stored in texture map storage facility 22. Furthermore, the 3D model data is separated onto line 34. The geometry information is in subsystem 24 subjected to geometry and lighting transformations to produce the geometry of the image that should eventually be displayed. Subsequently, in rasterizer subsystem 26 the texture maps from storage facility 22 must be applied into the image geometry. Next, in the preferred embodiment, the result is filtered in resample and filter unit 27. After successful completion of the filtering, the image is stored in frame buffer facility 28, for eventual display and associated refreshing in subsystem 30. In this preferred embodiment, with applying forward texture mapping and with an input driven filter, such as a transposed direct-form structure, the filter unit follows the rasterizer.

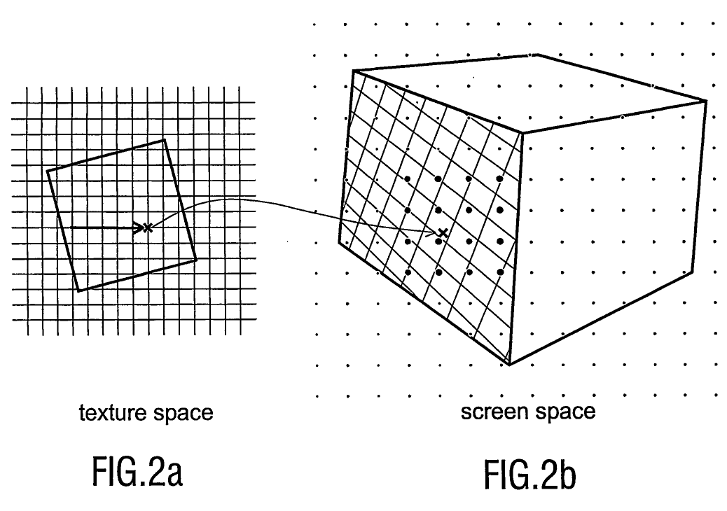

FIGS. 2a, 2b, illustrate the contributing from the mapping of a texel in texel space (FIG. 2a) as indicated by a cross, to the various pixels in screen space (FIG. 2b) that have been indicated by relatively heavy dots. The relatively lighter dots apparently will not receive a contribution from this particular texel. The values of the various contributions are of course governed by the filter shape. Futhermore, the mapping of a square in texture space on a perspective-containing quadrilateral in screen space has been shown through drawn lines. The variuos other sides of what represents apparently a cube in screen space have not been further considered herein.

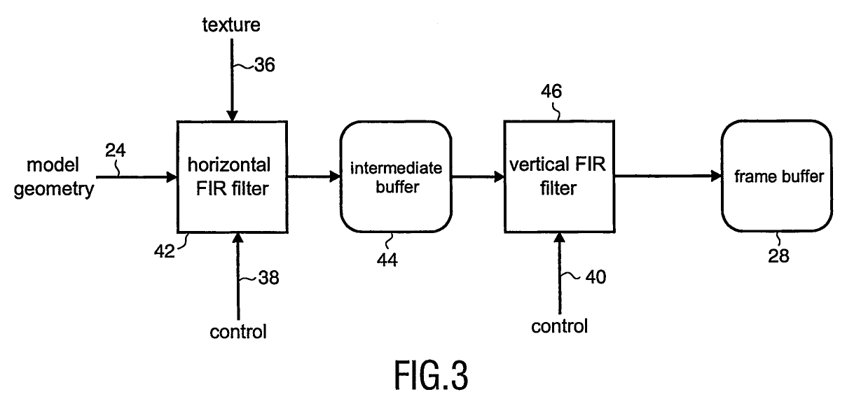

FIG. 3 illustrates a more detailed block diagram of the resample and filter unit of FIG. 1. The output from subsystem 24 in FIG. 1 is transferred to horizontal FIR filter 42 that furthermore receives the texture information from subsystem 22 in FIG. 1, as well as appropriate control signals from the rasterizer on line 38. The filtered information is transiently stored in the intermediate buffer facility 44 and subsequently transferred to vertical FIR filter 46 The intermediate buffer facility 44 can be avoided by interleaving the horizontal and the vertical resample pass on a per intermeiate pixel basis. The vertical Fir filter furthermore receives appropriate control signals from the rasterizer on line 40. Finally, the frame buffer facility 28 has been shown by way of replication from FIG. 1. This arrangement effectively executes two-dimensional filtering in two successive one-dimensional passes. In a different application, the two-pass technology has been described by Catmull-Smith, op. cit. The set-up can be used for the texture map function in a three-dimensional graphics system. The polygon, such as a triangle, is rasterized in the texture space.

Because forward texture mapping selects (possibly partially) those texels (covered by the pre-image) that contribute to a particular pixel, the mapping does not introduce unnecessary blurring or aliasing, as would have been the case with the conventionally used inverse texture mapping. In fact, inverse texture mapping furthermore has a problem with accurately selecting the texels that are within the quadrilateral pre-image of the pixel. Admittedly, the first pass, in the above case a horizontal one, may result in some loss of information. The reason therefor is that the input space can be mapped on a relatively small area in the intermediate space, relative to the output space. By itself, a solution to this information loss problem is to be readily found in prior art.

Now, the prime idea of the present invention is to use the known FIR filter structures for stepless variable sample rate conversion for implementing the texture map function in a three-dimensional graphics system. Such application transfers the application of such filter to a field of application that is novel and non-obvious for such application.

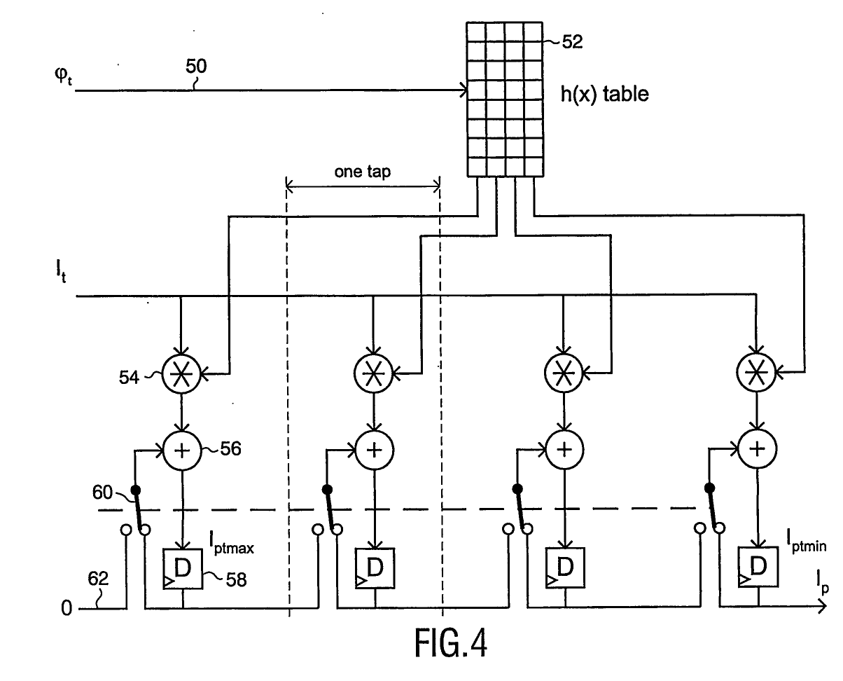

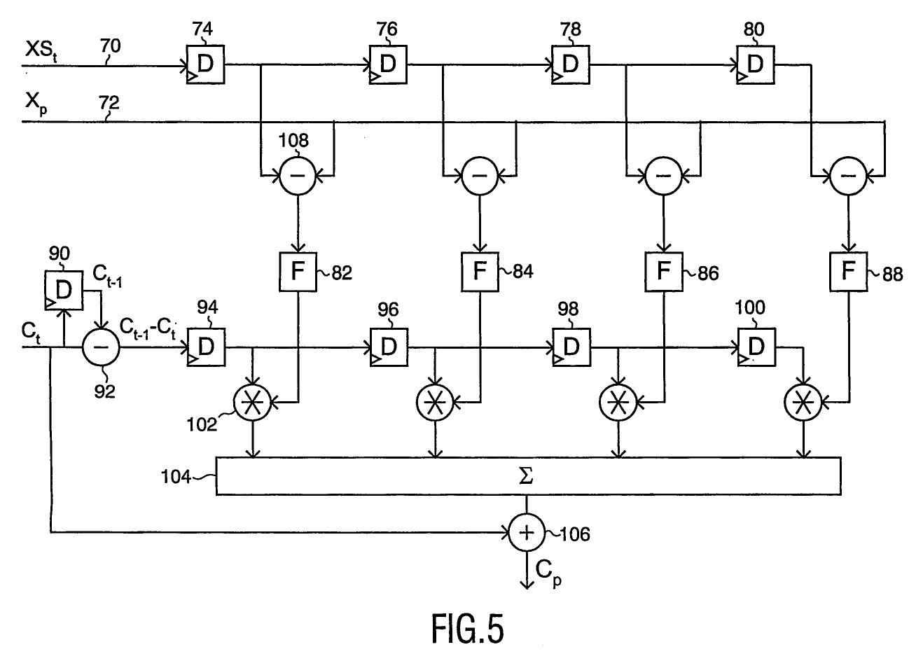

In this respect, FIG. 4 illustrates a polyphase transposed direct-form structure for such filter. FIG. 5 illustrates an alternatiev, a polyphase direct-form structure that can be used for such filter. The preferred embodiment of the present invention can be implemented with a two-pass procedure, using a FIR filter structure for both horizontal and vertical scaling. A polyphase direct-form structure has been disclosed in U.S. Pat. No. 4,472,732 assigned to AMPEX Corporation, but it can only been set to a discrete, and in consequence limited, number of scale factors. For every scale factor another filter function table is required, whereas in the method according to the present invention a steplessly variable scale factor is achieved with only a single filter function table. FIGS. 4 and 5 illustrate a one-dimensional structure that allows steplessly variable scaling that is usable for minification of the image. FIG. 4 shows a repetitive structure for four taps. Each tap receives an input value I in parallel with the others, and furthermore a coefficient from the single filter function h(x) table 52. The tap procedure has furthermore from top to bottom a multiplication of the input value I and the value from the coefficient table 52, an addition (56), a latched storage of the sum (58), and a retrocoupling from the output back to the addition 56. Synchronizing is effected by a signal on line 50, whereas data clearance is performed through serially loading zeroes from input 62 via switch 60. For the remainder, the various taps are identical.

A slightly different representation of the structure has been disclosed in the Van Dalfsen Patent, op. cit. The hardware structure implements a steplessly variable sample rate conversion, as may be described by the following expression:
Cₚ=Σ_{550 t}f(Xₜ−Xₚ)*Sₜ*Cₜ (1)

Equation (1) can be straightforwardly generalized to a single-pass two-dimensional steplessly variable sample rate conversion. Although the result has a comparable quality, the memory access is non-regular, leading to a less optimum usage of available memory bandwidth.

On the other hand, Equation (2) describes also a steplessly variable sample rate conversion. An additional advantage of this particular procedure is that no DC-ripple artifacts will be generated.
Cₚ=Σ_{∀t}((F(XMₜ₊₁−Xₚ)−F(XMₜ−Xₚ))*Cₜ) (2)

Various implementations of this expression in different environments have been described in earlier Patent Application PHINL010300 EPP, op. cit.

A still further implementation applies a direct-form structure for steplessly variable sample rate conversion for minification, although this requires a separate table for each respective tap. For this purpose, FIG. 5 illustrates the direct form structure that has earlier been published in the above earlier Patent Application. Although the structure as shown is operative for a one-dimensional case, the generalization to two-dimensional is trivial. In the arrangement of FIG. 5, there are again four taps as in FIG. 4, the XS quantity on line 70 being latched into successive stages 74, 76, 78, 80 and being delayed before entering into each next tap. Next, the value of Xₚ (72) is subtracted. The subtraction results will address the respective tables 82, 84, 86, 88 for producing the appropriate coefficient for multipliers 102. The structure at the lower left hand edge of the set-up will latch Cₜ, calculate a difference between two successive values of Cₜ in subtractor 92, and latch the result in successive elements 94, 96, 98, 100 for appropriate multiplication. The four results are then summed in item 104, and added once more to input value Cₜ in adder 106. The final output is Cₚ.

By itself, the polyphase structure of the filter is one of several possible implementations and by itself does not represent a restriction. With such polyphase filter, the weight of each tap depends both on the phase and also on the filter function. The phase is obtained by subtracting the coordinate of the mapped texel from the coordinate of a particular pixel whose colour is to be determined. For simplicity, a fixed filter function has been assumed.

Then, a table is constructed with every row of the table containing a quantised weight or coefficient for all taps that are active in a certain phase. Each table entry therefore has as many coefficient values stored as there are relevant taps. When executing the polyphase FIR filtering, for a certain texel a table index will be selected, according to the phase of that pixel, and all coefficients are fed to the relatively associated taps.

1. A method for executing a 3D computer graphics processing operation on information relating to a model of one or more three-dimensional objects, wherein said model includes texture information,
said method including a rendering step that comprises a transformation step allowing for both affine and for non-affine two-dimensional coordinate transformations, and comprising transforming said texture information,
said method being characterized by transforming the texture information through a spatially steplessly variable sample rate conversion.

2. A method as claimed in claim 1, wherein said sample rate conversion for a minification by a factor (1/a) is operative for arbitrary large values of a.

3. A system being arranged for implementing a method as claimed in claim 1, and comprising a rendering module that comprises a transformation element allowing for both affine and for non-affine twodimensional coordinate transformations, said transformation element allowing transforming said texture information,
said system comprising a spatially steplessly variable sample rate conversion module.

4. A system as claimed in claim 3, characterized in that said transformation element comprises a polyphase FIR filter structure.

5. A system as claimed in claim 4, wherein said filter structure is in transposed direct form.

6. A system as claimed in claim 4, wherein the prefilter function is stored in a table only once.

7. A system as claimed in claim 4, wherein said transformation element comprises a dirtect-form FIR filter structure, such that every tap has its own separate prefilter table.

8. A system as claimed in claim 4, wherein said filter executes its operations on texture coordinates that are transformed to an output space.

9. A system as claimed in claim 4, provided furthermore with inverse pixel transformation to the input space.

10. A system as claimed in claim 4, wherein said filter is operated in an input driven manner.

11. A system as claimed in claim 4, wherein said filter is operated in an output driven manner.

12. A system as claimed in claim 8, and being based on a combination of a vertical pass and a horizontal pass.
